(19) United States
(12) Patent Application Publication
(10) Pub. No.: US 2015/0229574 A1
(43) Pub. Date: Aug. 13, 2015

(54) COMMUNICATION SYSTEM, COMMUNICATION METHOD, INFORMATION PROCESSING APPARATUS, COMMUNICATION CONTROL METHOD, AND PROGRAM

(71) Applicant: NEC CORPORATION, Tokyo (JP)

(72) Inventors: Yasunobu Chiba, Tokyo (JP); Kazushi Sugyou, Tokyo (JP)

(73) Assignee: NEC Corporation, Tokyo (JP)

(21) Appl. No.: 14/429,754

(22) PCT Filed: Sep. 25, 2013
(86) PCT No.: PCT/JP2013/005672

§ 371 Date: Mar. 19, 2015

(30) Foreign Application Priority Data
Sep. 26, 2012 (JP) 2012-211729

(51) Int. Cl. H04L 12/805; H04L 12/46; H04L 12/801

(52) U.S. Cl. CPC H04L 47/365; H04L 47/12; H04L 12/4641

(57) ABSTRACT

A communication system includes a computing unit that transmits communication data with a plurality of packets and a communication unit that performs packet processing for transmitting the packets via a virtual network, and the computing unit adjusts a size of a transmission packet transmitted to the communication unit with a packet size selected from a plurality of packet size candidates based on information regarding a forwarding path of the transmission packet.

### CROSS-REFERENCE TO RELATED APPLICATIONS

The present invention is based upon and claims the benefit of the priority of Japanese patent application No. 2012-211729 filed on Sep. 26, 2012, the disclosure of which is incorporated herein in its entirety by reference thereto.

### TECHNICAL FIELD

The present invention relates to a communication system, communication method, information processing apparatus, communication control method, and program, and particularly to a communication system, communication method, information processing apparatus, communication control method, and program that perform communication using a virtual network.

### BACKGROUND

In recent years, networks such as a data center are often managed using a virtual network (for instance, overlay network) while the networks are distinguished for each user such as a corporation or group.

Patent Literature 1 discloses a technology that performs communication using an overlay network. A communication device of Patent Literature 1 encapsulates a packet in order to transmit the packet via the overlay network.

Patent Literature 2 discloses a technology in which, when a network connection device connects to a network using a VPN (Virtual Private Network), the network connection device asks a network control apparatus for an MTU (Maximum Transmission Unit) corresponding to the VPN.

### CITATION LIST

### Patent Literature

### [PTL 1]

United States patent: U.S. Pat. No. 8,166,205B2

### [PTL 2]

Japanese Patent Kokai Publication No. JP-P2009-171307A

### SUMMARY

### Technical Problem

The disclosures of above listed literatures are incorporated herein by reference into, and the following analysis made by the inventors of the present invention. Encapsulating each packet as in Patent Literature 1 may bottleneck the performance of a communication system. This performance bottleneck becomes more apparent as the communication amount (i.e., the number of packets) increases.

The performance bottleneck can be improved by adjusting the number of packets encapsulated by adjusting the MTU of a packet, as in Patent Literature 2. In Patent Literature 2, however, every time the network connection apparatus connects to a VPN, it asks the network control apparatus for an MTU corresponding to the VPN. Therefore, the bottleneck caused by the MTU inquiry becomes an issue.

It is an object of the present invention to reduce the performance bottleneck caused by packet processing when a virtual network such as an overlay network is utilized.

### Solution to Problem

According to a first aspect, there is provided a communication system. The communication system comprises a computing unit that transmits communication data with a plurality of packets and a communication unit that performs packet processing for transmitting the packets via a virtual network, and the computing unit adjusts a size of a transmission packet transmitted to the communication unit with a packet size selected from a plurality of packet size candidates based on information regarding a forwarding path of the transmission packet.

According to a second aspect, there is provided a communication method in a communication system comprising a computing unit that transmits communication data with a plurality of packets and a communication unit. The communication method comprises adjusting a size of a transmission packet with a packet size selected from a plurality of packet size candidates based on information regarding a forwarding path of the transmission packet, transmitting the transmission packet to the communication unit, and performing packet processing for transmitting the transmission packet via a virtual network.

According to a third aspect, there is provided an information processing apparatus. The information processing apparatus comprises a computing unit that transmits communication data with a plurality of packets and a communication unit that performs packet processing for transmitting the packets via a virtual network, and the computing unit adjusts a size of a transmission packet transmitted to the communication unit with a packet size selected from a plurality of packet size candidates based on information regarding a forwarding path of the transmission packet.

According to a fourth aspect, there is provided an information processing apparatus. The information processing apparatus comprises first means for generating a virtual machine that communicates with a communication unit which performs packet processing for transmitting a packet via a virtual network, and second means for setting information regarding a forwarding path of the packet and a packet size corresponding to the information in a storage unit to which the virtual machine refers in order to adjust a size of a transmission packet transmitted to the communication unit.

According to a fifth aspect, there is provided a communication control method. The communication control method comprises generating a virtual machine that communicates with a communication unit that performs packet processing for transmitting a packet via a virtual network, and setting information regarding a forwarding path of the packet and a packet size corresponding to the information in a storage unit to which the virtual machine refers in order to adjust a size of a transmission packet transmitted to the communication unit.

According to a sixth aspect, there is provided a program causing a computer to execute a process of generating a virtual machine that communicates with a communication unit that performs packet processing for transmitting a packet via a virtual network, and a process of setting information regarding a forwarding path of the packet and a packet size corresponding to the information in a storage unit to which the virtual machine refers in order to adjust a size of a transmission packet transmitted to the communication unit. This program can be recorded in a computer-readable (non-transient) storage medium. Namely, the present invention can be embodied as a computer program product.

### Advantageous Effects of Invention

According to the aspect of the present invention, an advantageous effect is provided that the performance bottleneck caused by packet processing when a virtual network such as an overlay network is used is reduced.

### BRIEF DESCRIPTION OF DRAWINGS

FIG. 1 is a block diagram illustrating a system configuration example of a first exemplary embodiment.

FIG. 2 is a block diagram illustrating an outline of a computing unit of the first exemplary embodiment.

FIG. 3 is a sequence diagram illustrating an operation example of the first exemplary embodiment.

FIG. 4 is a block diagram illustrating a system configuration example of a second exemplary embodiment.

FIG. 5 is a block diagram illustrating a configuration example of a computing unit of the second exemplary embodiment.

FIG. 6 is a block diagram illustrating a system configuration example of the second exemplary embodiment.

FIG. 7 is a drawing illustrating an operation example of the second exemplary embodiment.

FIG. 8 is a block diagram illustrating a system configuration example of a third exemplary embodiment.

FIG. 9 is a block diagram illustrating a configuration example of a control server of the third exemplary embodiment.

FIG. 10 is drawing illustrating an operation example of the third exemplary embodiment.

FIG. 11 is a drawing for explaining a technology related to a fourth exemplary embodiment.

FIG. 12 is a drawing for explaining the technology related to the fourth exemplary embodiment.

FIG. 13 is a block diagram illustrating a system configuration example of the fourth exemplary embodiment.

FIG. 14 is a block diagram illustrating an operation example of the fourth exemplary embodiment.

FIG. 15 is a block diagram illustrating a configuration example of a control server of the fourth exemplary embodiment.

FIG. 16 is a drawing illustrating examples of packet handling operations (processing rules) of the fourth exemplary embodiment.

FIG. 17 is a drawing illustrating a configuration example of a virtual switch of the fourth exemplary embodiment.

### DESCRIPTION OF EMBODIMENTS

### Exemplary Embodiment 1

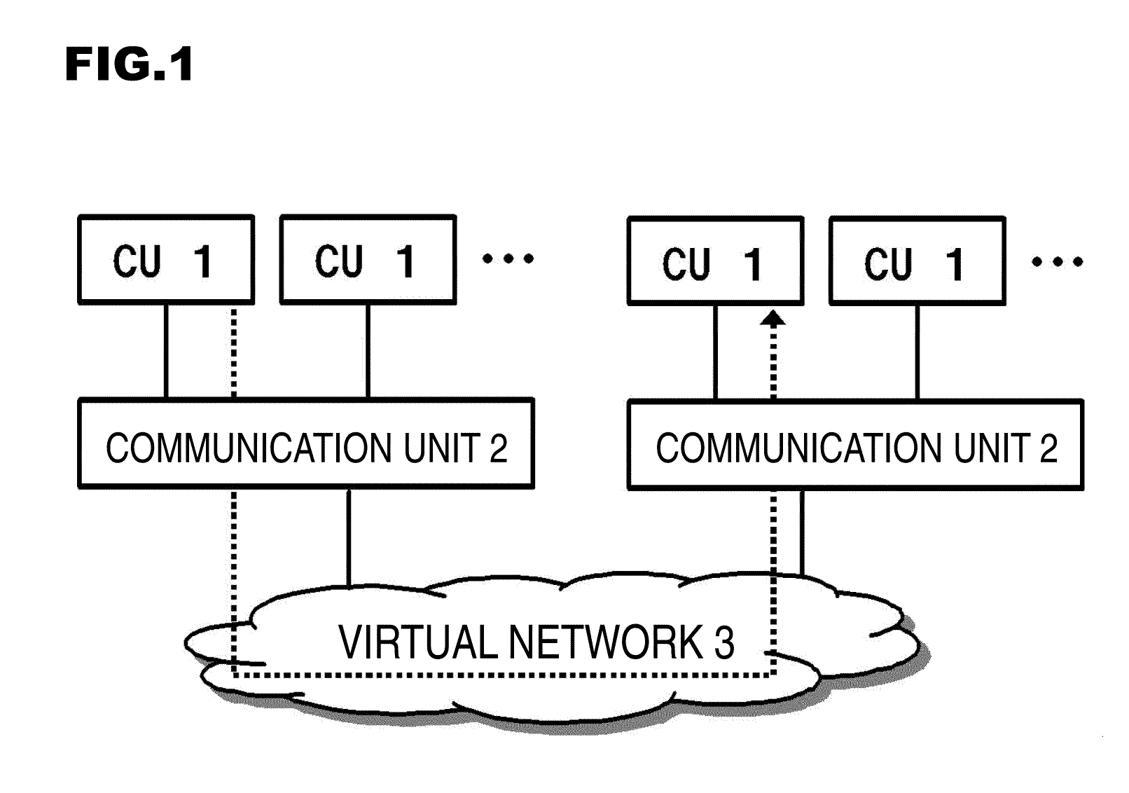

FIG. 1 shows a configuration example of a system of a first exemplary embodiment. FIG. 1 is an example and the configuration of the system of the present disclosure is not limited to FIG. 1.

The communication system of the first exemplary embodiment includes a computing unit (CU) 1, a communication unit 2, and a virtual network 3.

In the first exemplary embodiment, the CU1 has a function of adjusting a size of a transmission packet transmitted to the communication unit 2. Since the number of packets to be processed by the communication unit 2 can be adjusted due to the fact that the CU1 has the function of adjusting the size of a transmission packet, it becomes possible to deter a performance degradation caused by packet processing executed by the communication unit 2. Further, since the CU1 has a function of selecting a packet size from a plurality of packet sizes based on information regarding a forwarding path of a transmission packet, the performance bottleneck caused by inquiring the packet size to other apparatuses every time a connection is made to a virtual network can be avoided.

The communication unit 2 performs packet processing for transmitting a packet via the virtual network 3. The performance degradation caused by the packet processing depends on the number of packets on which the communication unit 2 performs the packet processing. Due to the function of adjusting the size of a transmission packet, the CU1 is able to increase the packet size. Because of the increase in the packet size, the number of the packets processed by the communication unit 2 is suppressed, making it possible to alleviate the performance degradation of the communication system.

For instance, the CU1 provides a user of the system with calculation processing using computational resources. The CU1 is, for instance, a server or virtual machine (VM) constructed on a server.

The CU1 has a function of communicating with another CU1 or communication terminal. The CU1 has a function of transmitting communication data using a plurality of packets.

The communication unit 2 has a function of forwarding a packet (or packets) transmitted or received by the CU1. The communication unit 2 has a function of transmitting a packet via the virtual network 3. When transmitting a packet via the virtual network 3, the communication unit 2 performs packet processing for adapting the packet to the virtual network 3.

For instance, the communication unit 2 is a virtual network switch configured by software. The communication unit 2 is constituted by, for instance, Open vSwitch (Open Virtual Switch).

For instance, the virtual network 3 is a new virtual network constructed over an existing network. The virtual network 3 is, for instance, an overlay network virtualized by VLAN (Virtual Local Area Network), GRE (Generic Routing Encapsulation), or VXLAN (Virtual Extensible VLAN) or the like. Note that the protocols listed here are examples, and the protocol used for constructing the virtual network 3 is not limited to these protocols.

For instance, the communication unit 2 performs processing that adds predetermined information (VLAN tag, for instance) to a packet in order to adapt the packet to the virtual network 3. Further, the communication unit 2 also performs processing that deletes the predetermined information added to the packet.

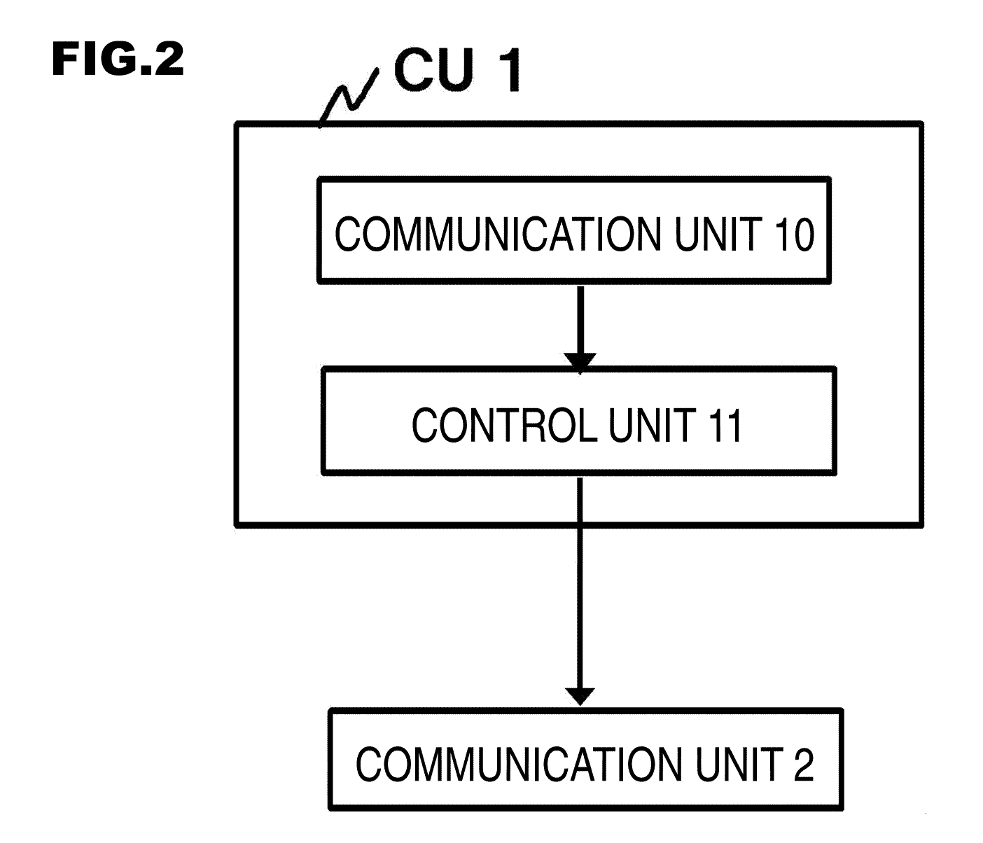

FIG. 2 shows an example of the CU1 of the first exemplary embodiment.

The CU1 includes a communication unit 10 and a control unit 11.

The communication unit 10 has a function of transmitting/receiving communication data. For instance, the communication unit 10 comprises a communication application.

The control unit 11 has a function of dividing communication data transmitted from the communication unit 10 into a plurality of packets. The control unit 11 has a function of adjusting the size of each packet.

For instance, the control unit 11 adjusts the size of a packet based on information regarding the forwarding path of the packet. The control unit 11 has the function of selecting a packet size from a plurality of packet size candidates based on the information regarding the forwarding path of a transmission packet.

A permitted size of a packet depends on the information regarding the forwarding path of the packet. The information regarding the forwarding path includes, for instance, information regarding a packet destination, or communication apparatuses (switch, router, firewall, load balance, etc.) that the forwarding path goes through. The permitted size of a packet depends on the size permitted by the packet destination or the size permitted by communication apparatuses on the forwarding path. Therefore, the control unit 11 adjusts the packet size based on the packet size permitted by the packet destination or by communication apparatuses.

For instance, the control unit 11 may adjust the size of a packet to a maximum permissible value of the packet size corresponding to the information regarding the forwarding path. For example, when the size permitted by the packet destination is 64 Kbytes (the maximum permissible value), the control unit 11 adjusts the size of a packet transmitted to the communication unit 2 to 64 Kbytes, the maximum permissible value of the destination. By adjusting the packet size to the maximum permissible value, the number of packets processed by the communication unit 2 is greatly decreased, and the performance degradation due to the packet processing executed by the communication unit 2 is reduced.

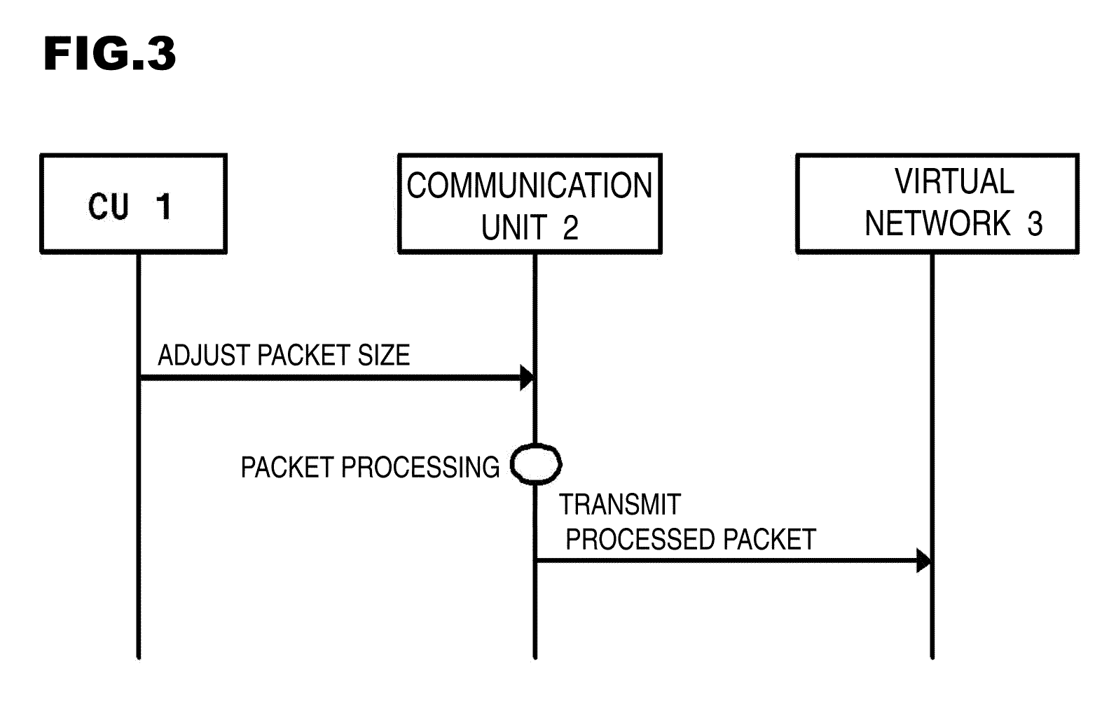

FIG. 3 is a sequence chart showing an operation example of the first exemplary embodiment.

When transmitting a packet to the communication unit 2, the CU1 adjusts the size of the transmission packet based on the information regarding the forwarding path of the transmission packet.

The communication unit 2 performs packet processing for adapting the reception packet to the virtual network. For instance, the communication unit 2 adds identification information (for instance, VLAN tag) for the virtual network to the packet. The communication unit 2 performs this processing on each of packets.

The communication unit 2 transmits the processed packet to the virtual network 3.

### Exemplary Embodiment 2

A second exemplary embodiment shows an example in which the size of a packet is set using a maximum transmission unit (MTU) of the packet.

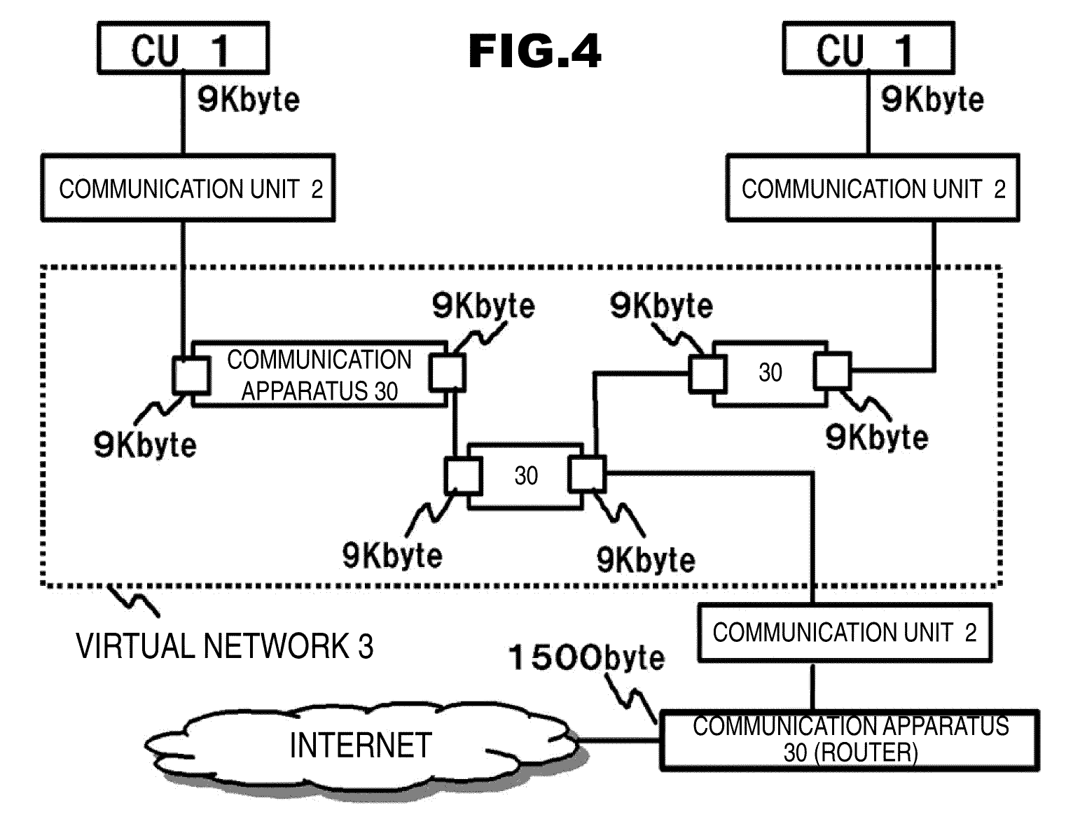

FIG. 4 shows a system configuration example of the second exemplary embodiment.

The virtual network 3 is constituted by a plurality of communication apparatuses 30. Each communication apparatus 30 has a plurality of ports. The communication apparatus 30 is a network appliance such as a switch, router, firewall, load balancer, etc.

For each port of the communication apparatus 30, an MTU is set. The MTU is the maximum amount value of the data transmitted per packet. An MTU is set for each port of the communication apparatus 30 as shown in the example of FIG. 4. Further, an MTU is set for the CU1 as well.

In the communication apparatuses 30 constituting the virtual network 3, the MTU for communicating with the virtual network 3 is set. In the example of FIG. 4, the MTU set for each port of the communication apparatus 30 is 9 Kbytes.

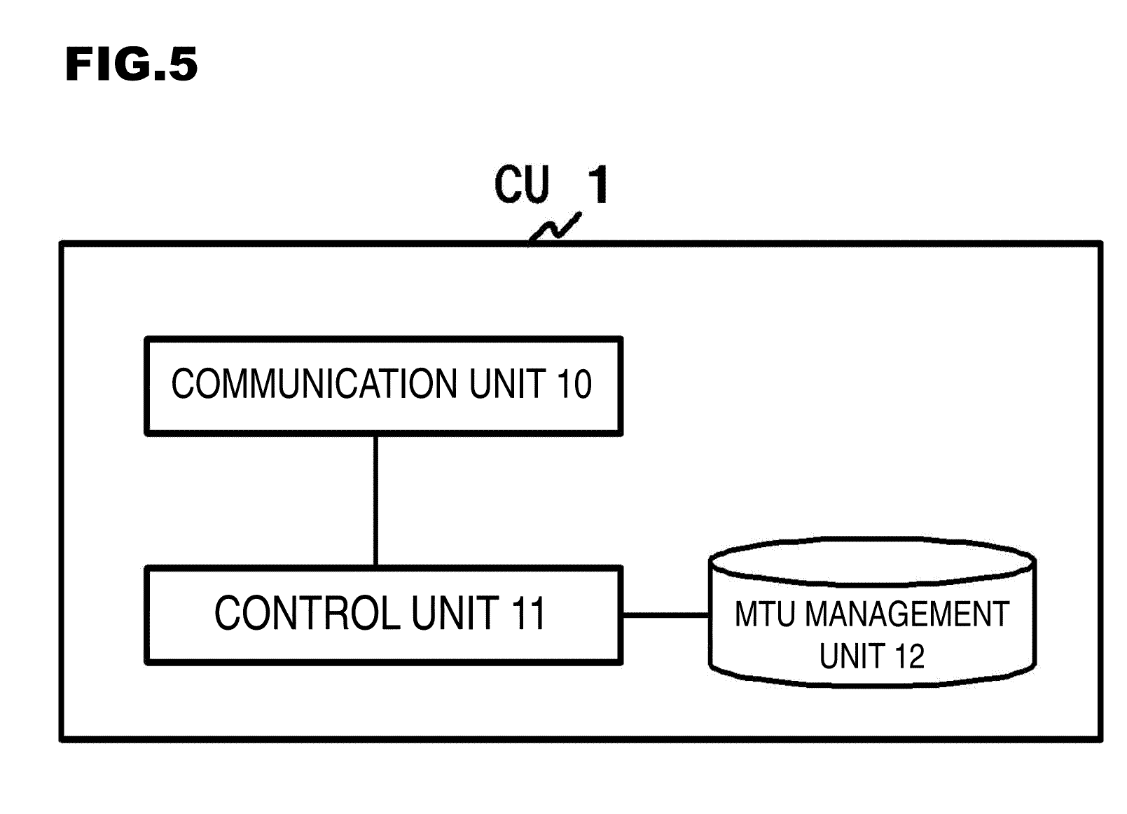

Further, the MTU for communicating with the virtual network is set for the CU1. FIG. 5 shows a configuration example of the CU1.

The CU1 comprises the communication unit 10, the control unit 11, and an MTU management unit 12. Since the communication unit 10 and the control unit 11 have the same functions as in the first exemplary embodiment, detailed explanation will be omitted.

The MTU management unit 12 manages an MTU corresponding to information regarding the forwarding path of a packet transmitted by the CU1. For instance, the MTU management unit 12 manages an MTU corresponding to the destination of a packet transmitted by the CU1.

The control unit 11 adjusts the size of a transmission packet based on information managed by the MTU management unit 12.

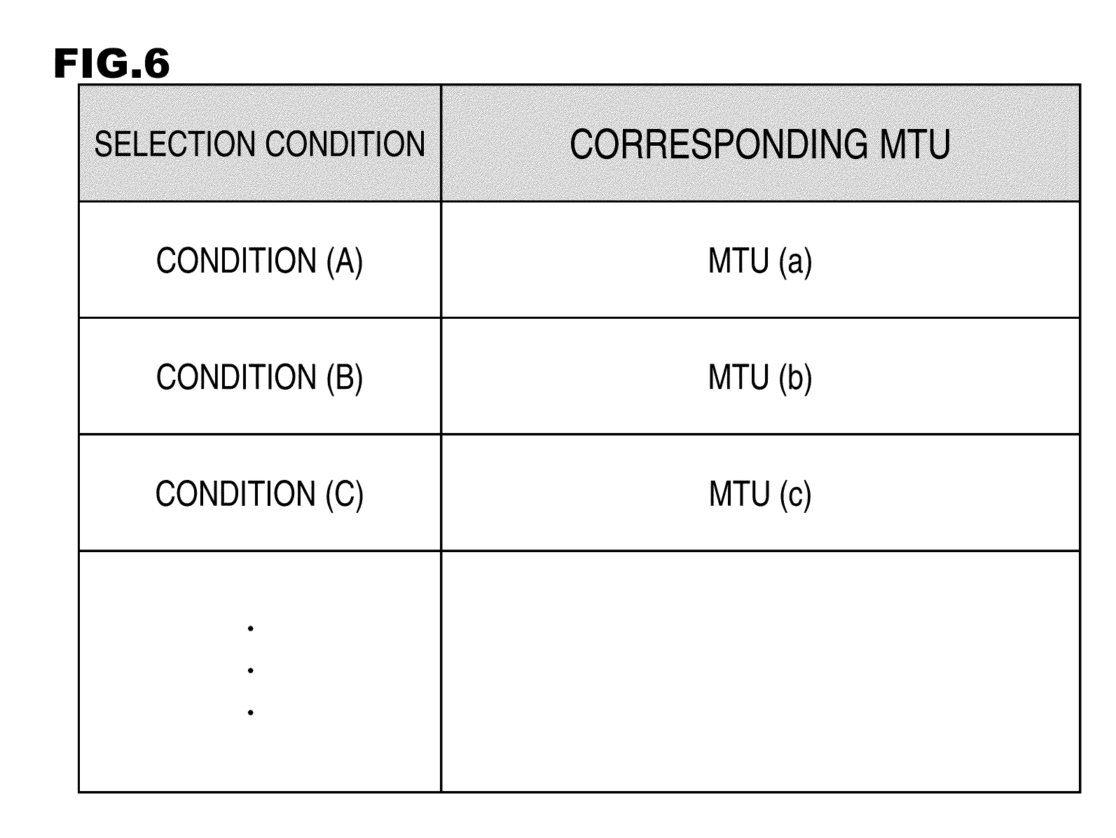

For instance, the MTU management unit 12 manages an MTU using a table shown in FIG. 6. The control unit 11 refers to the table possessed by the MTU management unit 12 and selects an MTU. The control unit 11 selects an MTU to be used based on selection conditions in the table.

The selection conditions in the table are set based on the information regarding the forwarding path of a packet. For instance, the selection condition may be the destination of the packet, and the control unit 11 selects an MTU according to the packet destination. For instance, the control unit 11 compares the destination address of the transmission data with the selection conditions, and selects an MTU corresponding to the selection condition that matches the destination address. The control unit 11 divides the transmission data into packets based on the selected MTU, and transmits the packets to the communication unit 2. Further, the control unit 11 may generate packets based on an MTU smaller than the selected MTU. In the example of FIG. 4, when a CU1 transmits a packet to another CU1, the size of the packet can be set to a maximum of 9 Kbytes. Meanwhile, as for a packet transmitted from the CU1 externally to the Internet, the maximum size of the packet is 1,500 bytes. This is because the MTU set for the communication apparatus 30 (router apparatus) that transmits the packet to the Internet is 1,500 bytes.

For instance, the selection conditions in the table may be set based on the communication apparatus 30 on the forwarding path of a packet. An MTU may be sometimes restricted depending on a type of the communication apparatus 30. For instance, when the communication apparatus 30 performs DPI (Deep Packet Inspection), the permitted MTU is restricted (to 9 Kbytes, for instance). The selection conditions in the table are set according to information for determining whether or not a packet goes through a particular communication apparatus 30. For instance, whether or not a packet goes through a particular communication apparatus 30 can be determined based on a protocol (TCP or UDP) or port number used in the communication. Therefore, the selection conditions in the table may be set according to protocol information or the port number.

When receiving a packet having a size larger than the MTU set for the port, the communication apparatus 30 performs processing that fragments the reception packet into the size of the set MTU, for instance. Further, when receiving a packet having a size larger than the MTU set for the port, the communication apparatus 30 discards the packet, for instance. The fragment and packet discard processing may cause performance degradation of the system.

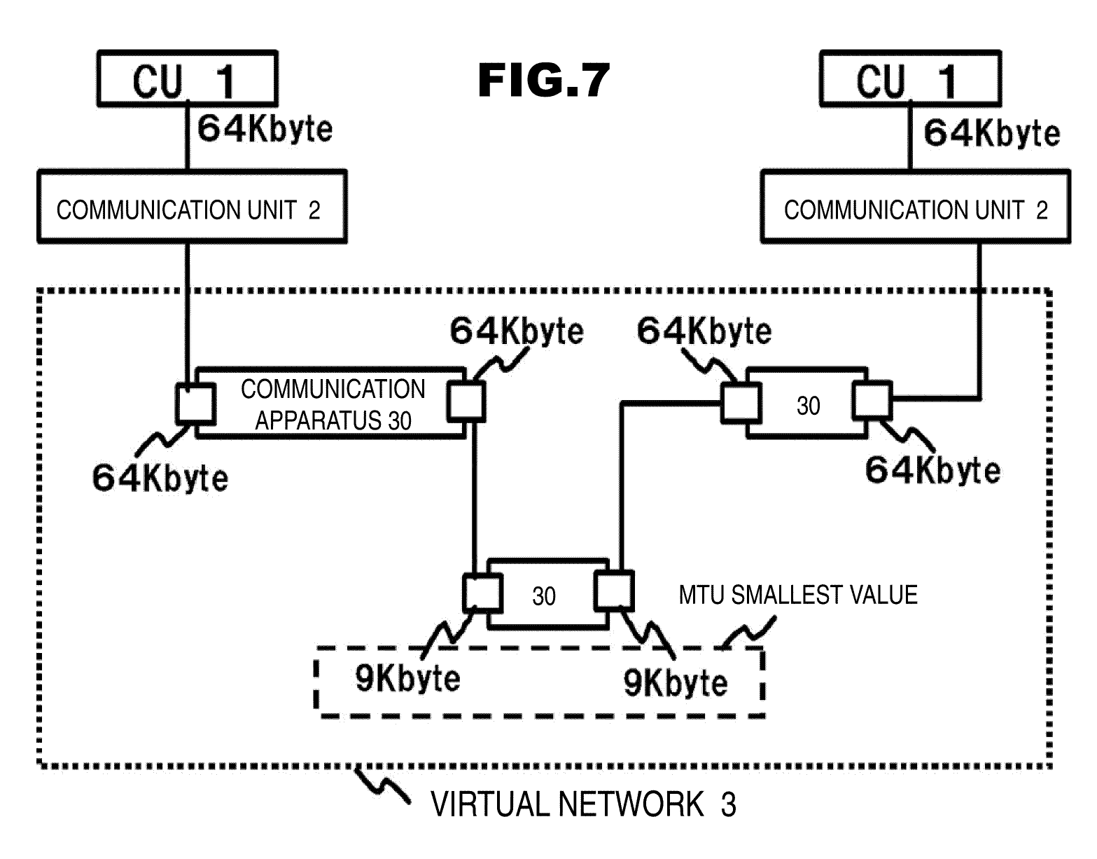

As shown in an example of FIG. 7, when some of the communication apparatuses 30 constituting the virtual network 3 have an MTU smaller than the other communication apparatuses 30, the fragment or packet discard processing may occur. In the example of FIG. 7, when the CU1 transmits a packet having a size of 64 Kbytes, the fragment or packet discard processing may occur in the communication apparatus 30 having the MTU set to 9 Kbytes.

In the case of the example in FIG. 7, the MTU set in the MTU management unit 12 may be the smallest value among a plurality of MTUs set in the forwarding path. For instance, in the example of FIG. 7, when the CU1 transmits a packet to another CU1, a smallest value among the MTUs set in the forwarding path (9 Kbytes in the example of FIG. 7) may be set in the MTU management unit 12. By setting the smallest value of the MTUs corresponding to the virtual network 3 in the CU1 as the MTU for communicating with the virtual network, the fragment and packet discard processing can be avoided. By avoiding the fragment and packet discard processing, performance degradation of the system can be reduced.

An MTU which is not smaller than the smallest value of the MTUs corresponding to the virtual network 3 may be set in the CU1. In other words, the CU1 may transmit a packet using the MTU set therein, regardless of the smallest value of the MTUs corresponding to the virtual network 3. In a case where the communication apparatuses 30 corresponding to the virtual network are apparatuses corresponding to the network layer (layer 3) of the OSI (Open Systems Interconnection) reference model, the CU1 is assumed to receive an error message (“Packet Too Big” message) according to ICMP (Internet Control Message Protocol) when a packet transmitted by the CU1 is larger than the smallest MTU in the virtual network. When the ICMP error message is received, the CU1 can decrease the MTU of the transmission packet. Or the CU1 may have the communication apparatus 30 divide (into fragments) the packet having a larger size than the set MTU. For instance, if the performance degradation caused by the dividing processing is small, the CU1 may not have to change the MTU even when receiving the ICMP error message.

### Exemplary Embodiment 3

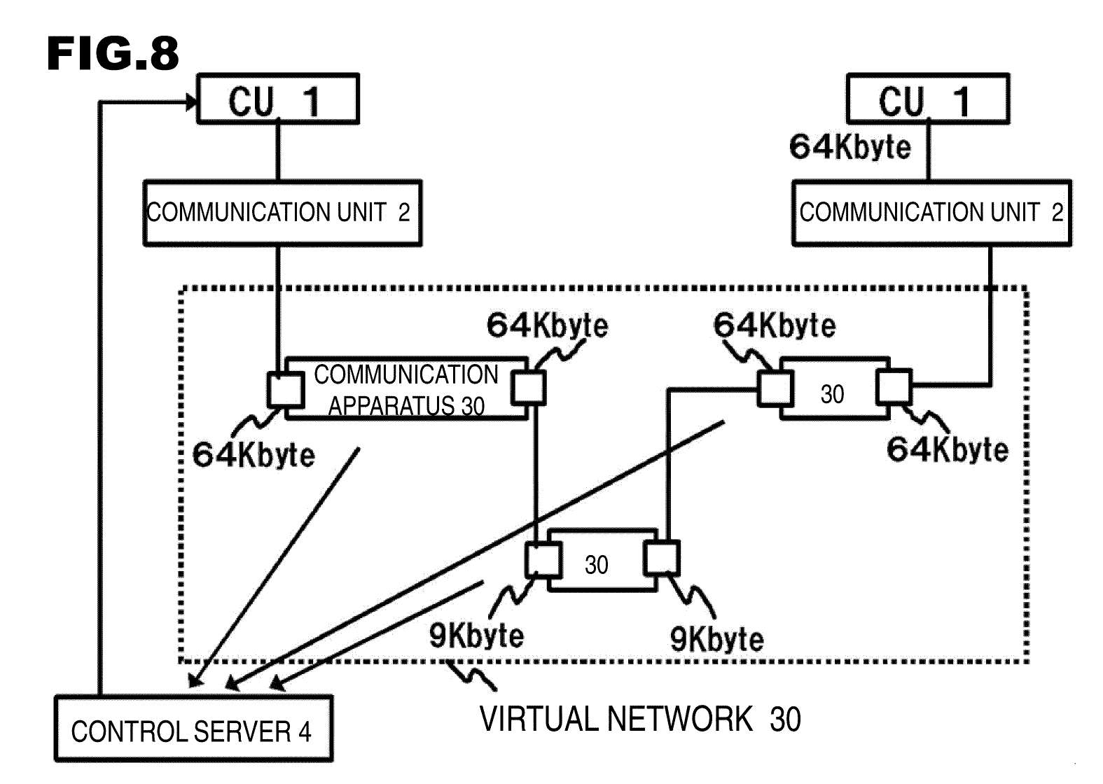

FIG. 8 shows a system configuration example of a third exemplary embodiment. The third exemplary embodiment shows an example in which a control server 4 collects MTUs set in the communication apparatuses 30 constituting the virtual network 3. Since the control server 4 can control (or manage) the MTUs set in the virtual network 3 in a consolidated fashion, an MTU to be set in the CU1 can be easily determined.

The system of the third exemplary embodiment comprises the control server 4. The control server 4 collects the MTUs set in the communication apparatuses 30 constituting the virtual network 3. The control server 4 sets an MTU for the communication by the virtual network in the CU1 based on the collected MTUs.

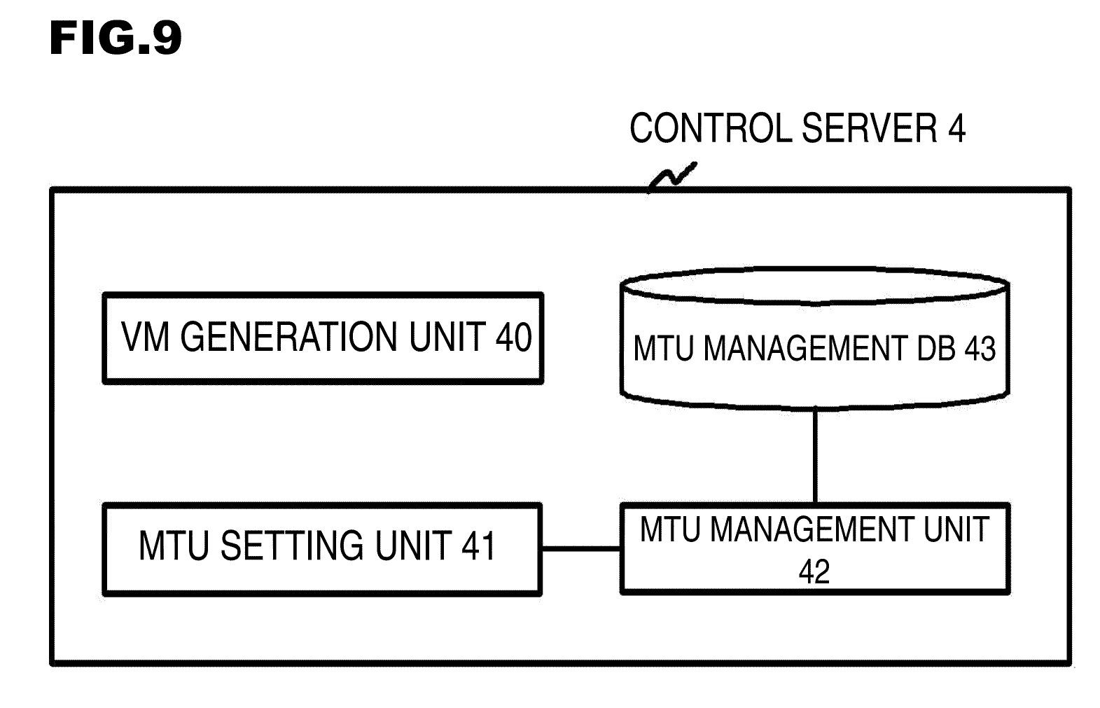

FIG. 9 shows a configuration example of the control server 4.

An MTU management unit 42 collects MTU information from apparatuses (the CU1 and the communication apparatus 30) in the communications system and manages the collected MTUs using an MTU management DB (Database) 43.

For instance, the MTU management unit 42 collects MTUs using SNMP (Simple Network Management Protocol). The communication apparatus 30 manages the MTU information set for each port using an MIB (Management Information Base). For instance, the MTU management unit 42 requests the MTU information from the communication apparatus 30 with a “Get Request” message of SNMP. The communication apparatus 30 transmits the MTU information to the MTU management unit 42 with, for instance, a “Get Response” message.

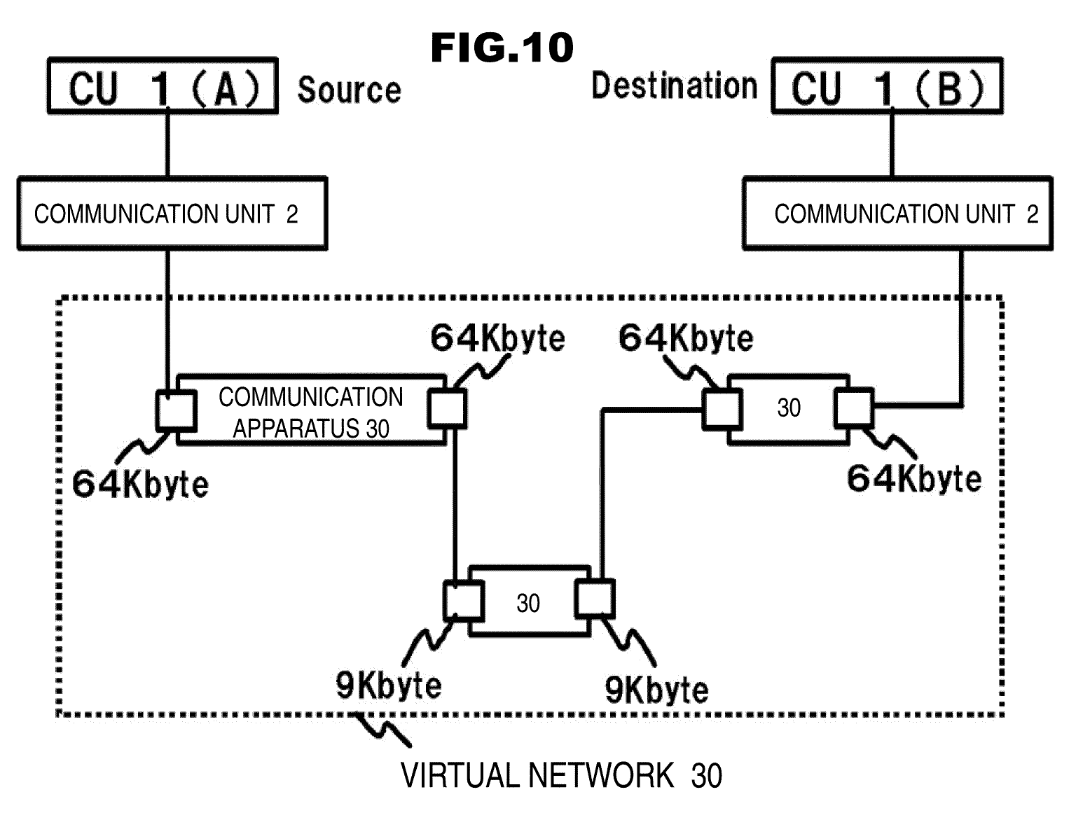

An MTU setting unit 41 sets an MTU in the CU1 based on the MTUs collected by the MTU management unit 42. For instance, the MTU setting unit 41 sets an MTU in the CU1 based on the MTU of the communication apparatus 30 that a packet goes through when the packet is forwarded from the source to the destination. In an example of FIG. 10, it is assumed that a CU1 (A) transmits a packet to a CU1 (B), for instance. The MTU setting unit 41 refers to the MTUs collected by the MTU management unit 42, and searches for the smallest MTU on the path from the CU1 (A) to the CU1 (B). The MTU setting unit 41 sets the smallest MTU on the path (9 Kbytes in the example of FIG. 10) in the MTU management unit 12 of the CU1 (A) as the MTU of the packet heading for the CU1 (B). For instance, the MTU setting unit 41 sets the MTU in the MTU management unit 12 using the table format shown in FIG. 6.

The MTU setting unit 41 sets an MTU in each CU1 in the system using the method described above.

Since the control server 4 sets an MTU in each CU1, work load of a system operator what manually sets an MTU in each CU1 is reduced. Further, the MTU set by the control server 4 enables each CU1 to select an appropriate MTU for each communication. As a result, the load of the packet processing performed by the communication unit 2 is reduced, improving a communication performance of the system.

In addition to collecting MTUs and setting an MTU in the CU1, the control server 4 may have other functions. For instance, the control server 4 may have a function for integrated operation management of the system. For instance, the control server 4 has a VM generation unit 40 as a function for integrated operation management of the system.

The VM generation unit 40 has a function of generating a virtual machine (VM) on a server of the system. The VM generation unit 40 generates a virtual machine using server resources (CPU, memory etc.). For instance, the VM generation unit 40 constitutes the CU1 using a VM. Further, when the VM generation unit generates a VM, it may set an MTU in the VM. The VM generation unit 40 notifies the MTU management unit 42 of the MTU set in the VM.

The VM generation unit 40 may generate the communication unit 2, which is a virtual switch constituted by software. The communication unit 2 generated by the VM generation unit 40 is a virtual switch constituted by software and has the same functions as a physical switch.

The MTU setting unit 41 may set an MTU in the CU1 when the VM generation unit 40 generates the CU1 and the communication unit 2.

Note that the control server 4 is not required to have a function corresponding to the VM generation unit 40.

### Exemplary Embodiment 4

A fourth exemplary embodiment shows an example in which the present disclosure is executed by improving on a technology called OpenFlow having a centrally controlled architecture.

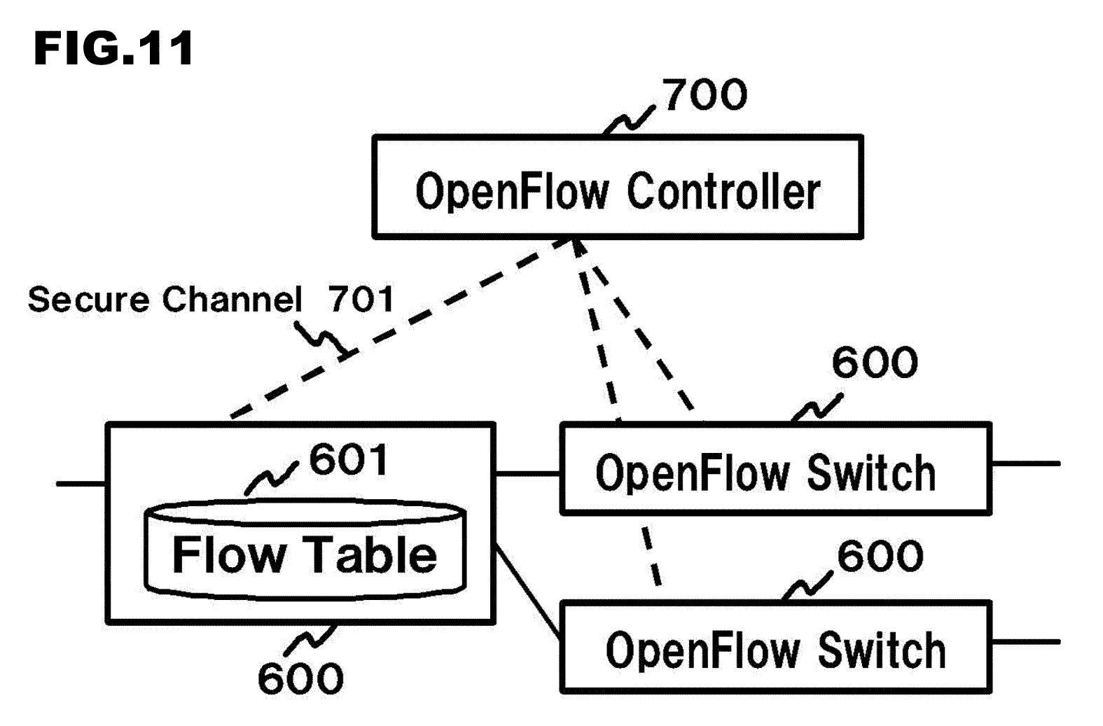

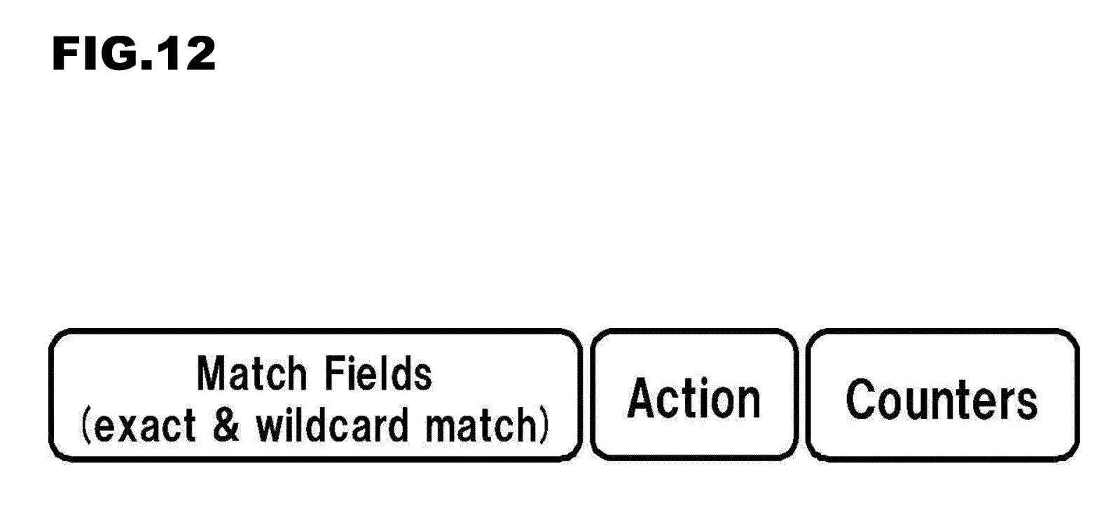

OpenFlow will be explained with reference to FIGS. 11 and 12.

OpenFlow recognizes communication as an end-to-end flow, and performs path control, failure recovery, and load balancing for each flow. FIG. 11 shows an overview of a communication system constituted by OpenFlow. Note that a flow is a series of communication packets having, for instance, a certain attribute. An OpenFlow switch 600 is a network switch that employs the OpenFlow technology. An OpenFlow controller 700 is an information processing apparatus that controls the OpenFlow switch 600.

The OpenFlow switch 600 communicates with the OpenFlow controller 700 via a secure channel 701 configured between an OpenFlow switch and an OpenFlow controller. The OpenFlow controller 700 performs setting of a flow table 601 of the OpenFlow switch 600 via the secure channel 701. Note that the secure channel 701 is a communication path for the communication between the switches and the controller.

FIG. 12 shows a configuration example of each entry (flow entry) in the flow table 601. A flow entry is constituted by a matching rule to be matched with information of a packet received by a switch (for instance, the destination IP address, VLAN ID, etc.), statistical information (Counters), which is statistical information of each packet flow, and an action (Actions) that defines a method for processing a packet matching the matching rule.

When receiving a packet, the OpenFlow switch 600 refers to the flow table 601. The OpenFlow switch 600 searches for a flow entry that matches header information of the reception packet. When an entry matching the header information of the reception packet is found, the OpenFlow switch 600 processes the reception packet according to a processing method defined in the action field of the searched entry. The processing method includes, for instance, “forward the reception packet from a predetermined port,” “discard the reception packet,” and “rewrite a part of the header of the reception packet and forward it from a predetermined port.”

Meanwhile, when an entry matching the header information of the reception packet is not found, the OpenFlow switch 600 forwards the reception packet to the OpenFlow controller 700 via the secure channel 701, for instance. The OpenFlow switch 600 requests the controller to set a flow entry that defines a processing method for the reception packet by forwarding the reception packet. Further, when the reception packet matches an entry that requests the OpenFlow controller 700 to set a flow entry, the OpenFlow switch 600 may request the OpenFlow controller 700 to set a flow entry.

The OpenFlow controller 700 determines the processing method for the reception packet and sets a flow entry including the determined processing method in the flow table 601. Then, the OpenFlow switch 600 processes subsequent packets belonging to the same flow as the reception packet according to the set flow entry.

The control server 400 of the fourth exemplary embodiment is configured by improving the OpenFlow technology described above. The control server 400 has a function of controlling a communication unit 2a based on the OpenFlow protocol, in addition to the functions possessed by the control server 4 of the third exemplary embodiment. The communication unit 2a has a function of operating according to the OpenFlow protocol, in addition to the functions possessed by the communication unit 2.

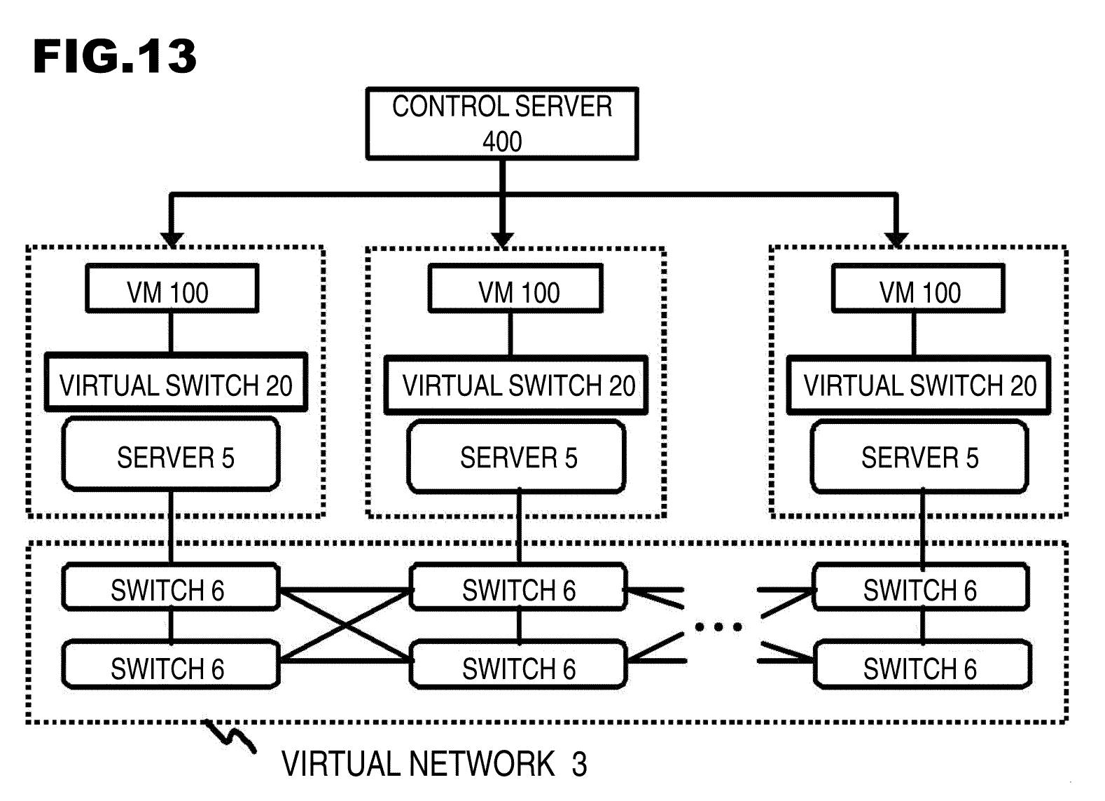

FIG. 13 shows a system configuration example of the fourth exemplary embodiment.

The system of the fourth exemplary embodiment includes a network constituted by a switch 6, a VM100 constructed by (on) a server 5 located at an edge of the network, a virtual switch 20 constructed by the server 5, and the control server 400. The system may include a plurality of the control servers 400. The VM100 has the same functions as the CU1 illustrated in FIG. 5. The VM100 is a virtual machine constructed by the control server 400. The virtual switch 20 is a software switch constructed by the control server 400 and has the same functions as the communication unit 2.

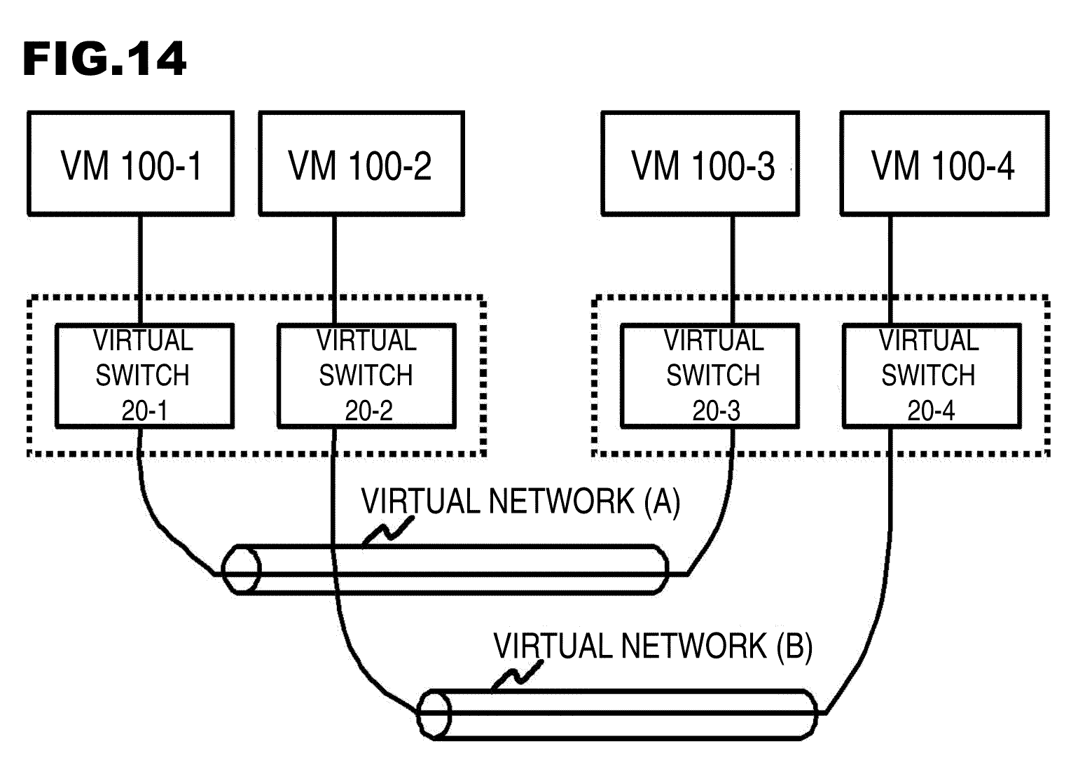

For instance, the virtual switch 20 transmits a packet transmitted from the VM100 to another VM100, a communication partner, via the virtual network 3. FIG. 14 shows a communication operation example of the fourth exemplary embodiment.

A VM100-1 transmits a packet to a virtual switch 20-1. The VM100-1 adjusts the packet size based on information regarding the forwarding path of the packet. The virtual switch 20-1 encapsulates the reception packet using an identifier of the virtual network. In the example of FIG. 14, the virtual switch 20-1 encapsulates the packet using a virtual network ID (A). A virtual switch 20-3 decapsulates (removes the capsule form) the packet encapsulated using the virtual network ID (A) and forwards the packet to a VM100-3.

A VM100-2 transmits a packet to a virtual switch 20-2. The VM100-2 transmits the packet using an MTU for the communication with the virtual network. The virtual switch 20-2 encapsulates the reception packet using an identifier of the virtual network. In the example of FIG. 14, the virtual switch 20-2 encapsulates the packet using a virtual network ID (B). A virtual switch 20-4 decapsulates (removes the capsule form) the packet encapsulated using the virtual network ID (B) and forwards the packet to a VM100-4.

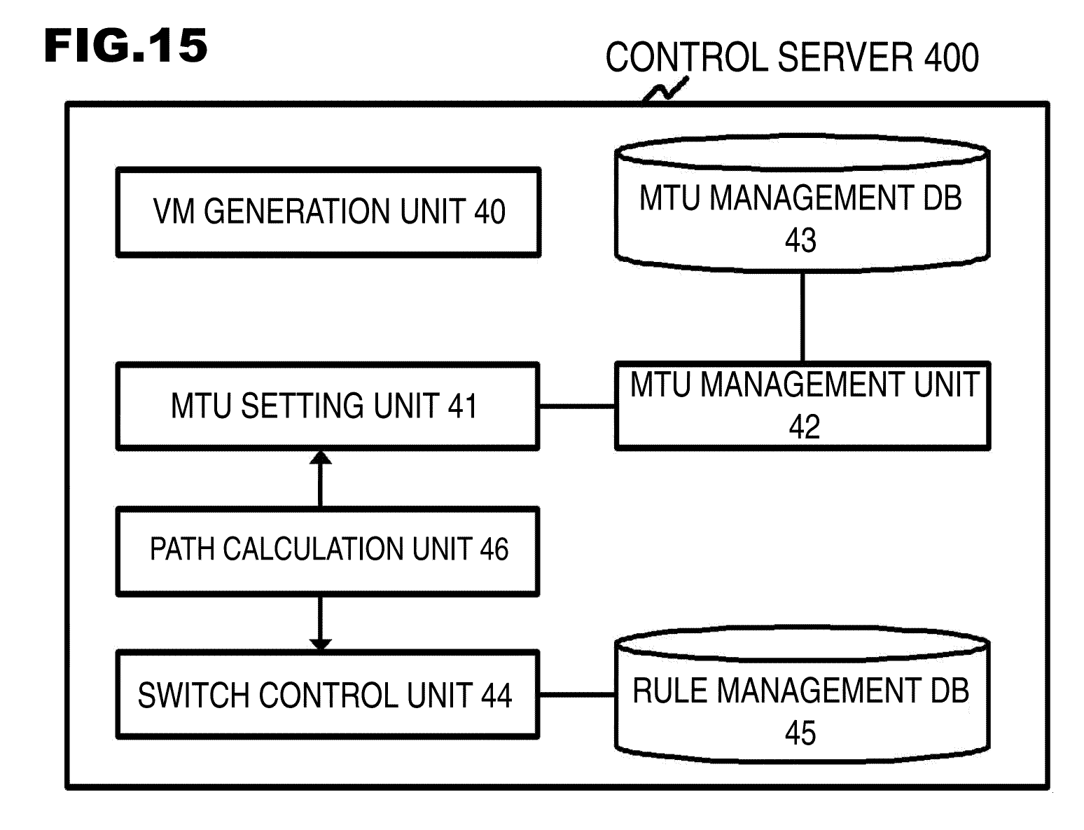

FIG. 15 shows a configuration example of the control server 400.

A VM generation unit 40, an MTU setting unit 41, an MTU management unit 42, and an MTU management DB 43 have the same functions as in the example described in the third exemplary embodiment.

A switch control unit 44 generates a packet handling operation (i.e., processing rule) to be notified to the virtual switch 20. The switch control unit 44 notifies a generated packet handling operation to the virtual switch 20. The switch control unit 44 manages packet handling operations using a rule management DB 45.

For instance, the switch control unit 44 generates a packet handling operation corresponding to the forwarding path of a packet determined by a path calculation unit 46, and notifies the packet handling operation to the virtual switch 20. For instance, the path calculation unit 46 selects a virtual network to which a packet is forwarded from a plurality of virtual networks.

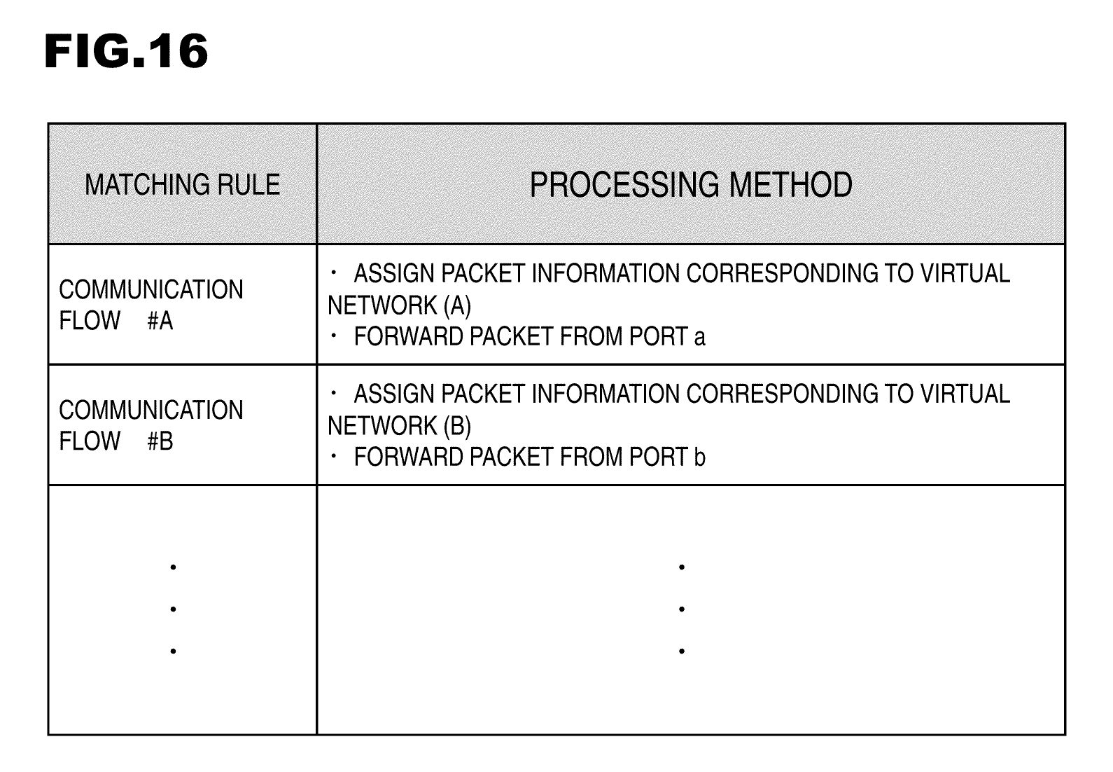

FIG. 16 shows examples of the packet handling operations. A packet handling operation includes, for instance, a matching rule and processing method.

The matching rule is, for instance, a condition for identifying a packet as a communication flow. A communication flow is a series of packets identified by a predetermined condition. The matching rule is a rule specified based on information included in a packet such as a packet transmitted to a predetermined destination or packet transmitted from a predetermined source.

The processing method defines processing applied to a packet that matches the matching rule.

For instance, the switch control unit 44 sets the packet handling operation (processing rule) in the first row of FIG. 16 in the virtual switch 20-1 in FIG. 14. “Communication Flow #A” in the first row of FIG. 16 is, for instance, a communication flow sent from the VM100-1 to the VM200-2. For instance, if the path calculation unit 46 assigns the virtual network (A) to “Communication Flow #A,” the switch control unit 44 encapsulates a packet belonging to “Communication Flow #A” using the identifier of the virtual network (A), and notifies a packet handling operation ordering the packet to be forwarded from a port a of the virtual switch 20-1 to the virtual switch 20-1. For instance, the switch control unit 44 sets the packet handling operation in the second row of FIG. 16 in the virtual switch 20-2.

For instance, when a new VM is generated by the VM generation unit 40, the switch control unit 44 sets a packet handling operation for a virtual switch 20 corresponding to the newly generated VM.

The MTU setting unit 41 may set an MTU in the VM100 in response to the path calculation unit 46 determining a virtual network corresponding to a communication flow. The MTU setting unit 41 sets an MTU corresponding to the virtual network determined by the path calculation unit 46 in the VM100. For instance, in the VM100, the MTU setting unit 41 sets the smallest MTU on the communication path corresponding to the virtual network determined by the path calculation unit 46.

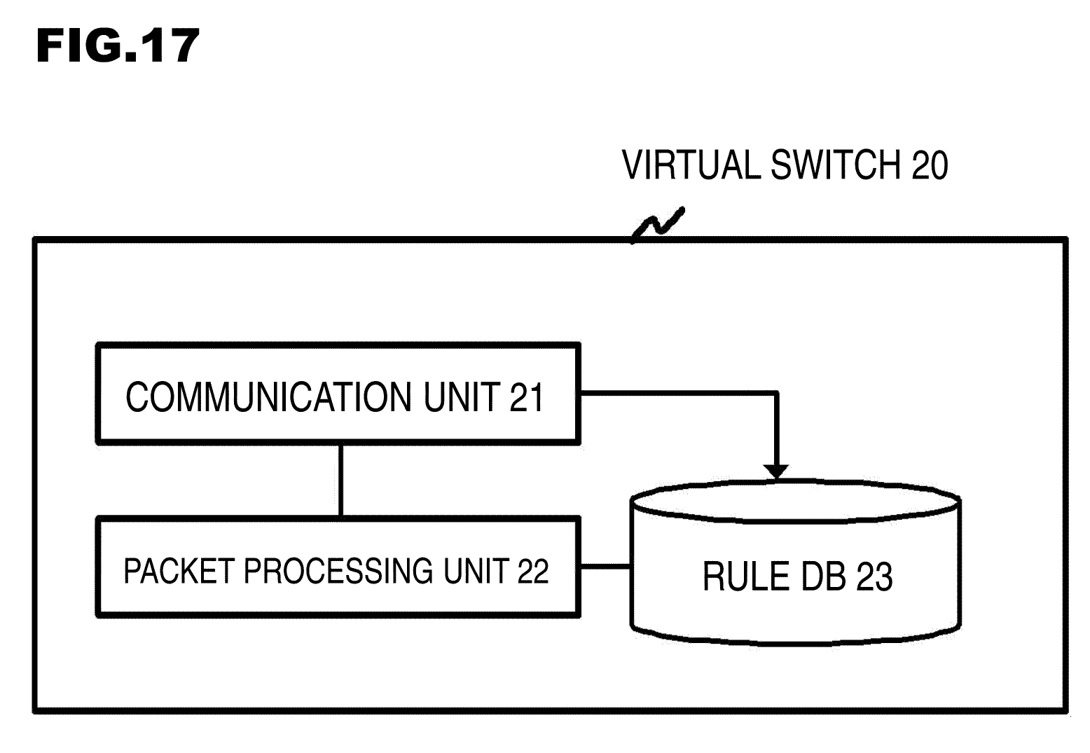

FIG. 17 shows a configuration example of the virtual switch 20.

A communication unit 21 communicates with the control server 400 according to the OpenFlow protocol. The communication unit 21 receives a packet handling operation notified from the control server 400. The communication unit 21 stores the packet handling operation received from the control server 400 in a rule DB 23.

A packet processing unit 22 searches for a packet handling operation matching a reception packet in the rule DB 23. The packet processing unit 22 searches for a packet handling operation having a matching rule that matches information included in the reception packet. The packet processing unit 22 processes the reception packet according to the processing method defined in the searched packet handling operation.

For instance, the packet processing unit 22 requests a packet handling operation matching the reception packet from the control server 400. The switch control unit 44 of the control server 400 generates a packet handling operation in response to the request, and transmits the packet handling operation to the virtual switch 20. The packet processing unit 22 may send an inquiry to the control server 400 when a packet handling operation matching the reception packet defines a processing method that indicates an inquiry about a packet handling operation to the control server 400.

Finally, preferable modes of the present invention will be summarized.

### <First Mode>

(See the communication system in the above first aspect)

### <Second Mode>

In the communication system in the first mode, the computing unit comprises a storage unit that stores a maximum permissible value of a packet size corresponding to information regarding the forwarding path, and the computing unit is able to adjust the packet size of the transmission packet to the maximum permissible value.

### <Third Mode>

In the communication system in the first or second mode, the computing unit adjusts the packet size of the transmission packet based on a smallest value among a plurality of maximum transmission units set on the forwarding path.

### <Fourth Mode>

In the communication system in any one of the first to third modes, the computing unit adjusts the packet size of the transmission packet to a smallest value among maximum transmission units set on each of a plurality of communication apparatuses constituting the forwarding path.

### <Fifth Mode>

In the communication system in any one of the first to fourth modes, the computing unit adjusts the packet size of the transmission packet to a maximum transmission unit corresponding to a destination of the transmission packet.

### <Sixth Mode>

In the communication system in any one of the first to fourth modes, the computing unit adjusts the packet size of the transmission packet to a maximum transmission unit corresponding to a communication apparatus that performs predetermined processing on the transmit packet on the forwarding path.

### <Seventh Mode>

In the communication system in any one of the first to sixth modes, the communication system comprises a control apparatus that collects maximum transmission units set on the forwarding path, and sets a maximum transmission unit calculated by an operation having at least one of collected maximum transmission units as an input and information regarding the forwarding path in the computing unit such that the calculated maximum transmission unit is associated with the information regarding the forwarding path.

### <Eighth Mode>

(See the communication method in the above second aspect)

### <Ninth Mode>

In the communication method in the eighth mode, the communication method comprises adjusting the packet size of the transmission packet to a maximum permissible value of a packet size corresponding to information regarding the forwarding path.

### <Tenth Mode>

In the communication method in the eighth or ninth mode, the communication method comprises adjusting the packet size of the transmission packet based on a smallest value among a plurality of maximum transmission units set on the forwarding path.

### <Eleventh Mode>

In the communication method in any one of the eighth to tenth modes, the communication method comprises adjusting the packet size of the transmission packet to a smallest value among maximum transmission units set on each of a plurality of communication apparatuses constituting the forwarding path.

### <Twelfth Mode>

In the communication method in any one of the eighth to eleventh modes, the communication method comprises adjusting the packet size of the transmission packet to a maximum transmission unit corresponding to a destination of the transmission packet.

### <Thirteenth Mode>

In the communication method in any one of the eighth to eleventh modes, the communication method comprises adjusting the packet size of the transmission packet to a maximum transmission unit corresponding to a communication apparatus that performs predetermined processing on the transmit packet on the forwarding path.

### <Fourteenth Mode>

In the communication method in any one of the eighth to thirteenth modes, the communication method comprises: collecting maximum transmission units set on the forwarding path; and setting a maximum transmission unit calculated by an operation having at least one of collected maximum transmission units as an input and information regarding the forwarding path in the computing unit such that the calculated maximum transmission unit is associated with the information regarding the forwarding path.

### <Fifteenth Mode>

(See the information processing apparatus in the above third aspect)

### <Sixteenth Mode>

(See the information processing apparatus in the above fourth aspect)

### <Seventeenth Mode>

In the information processing apparatus in the sixteenth mode, the second means sets a maximum permissible value of a packet size corresponding to information regarding the forwarding path in the storage unit.

### <Eighteenth Mode>

In the information processing apparatus in the sixteenth or seventeenth mode, the second means sets a maximum permissible value of a packet size corresponding to information regarding the forwarding path in the storage unit.

### <Nineteenth Mode>

In the information processing apparatus in the sixteenth or eighteen mode, the second means collects maximum transmission units set on the forwarding path, and sets a maximum transmission unit calculated by an operation having at least one of collected maximum transmission units as an input and information regarding the forwarding path in the storage unit such that the calculated maximum transmission unit is associated with the information regarding the forwarding path.

### <Twentieth Mode>

In the information processing apparatus in the sixteenth or nineteenth mode, the second means sets a packet size in the storage unit based on a smallest value among maximum transmission units set on each of a plurality of communication apparatuses constituting the forwarding path.

### <Twenty-First Mode>

In the information processing apparatus in the sixteenth or nineteenth mode, the second means sets a maximum transmission unit corresponding to a destination of the transmission packet in the storage unit.

### <Twenty-Second Mode>

In the information processing apparatus in the sixteenth or nineteenth mode, the second means sets a maximum transmission unit corresponding to a communication apparatus that performs predetermined processing on the transmit packet on the forwarding path in the storage unit.

### <Twenty-Third Mode>

(See the communication control method in the above fifth aspect)

### <Twenty-Fourth Mode>

(See the program in the above sixth aspect)

The entire disclosures of the above NPLs are incorporated herein by reference thereto. Modifications and adjustments of the exemplary embodiments and examples are possible within the scope of the overall disclosure (including the claims) of the present invention and based on the basic technical concept of the present invention. Various combinations and selections of various disclosed elements (including the elements in each of the claims, exemplary embodiments, examples, drawings, etc.) are possible within the scope of the claims of the present invention. That is, the present invention of course includes various variations and modifications that could be made by those skilled in the art according to the overall disclosure including the claims and the technical concept. The description discloses numerical value ranges. However, even if the description does not particularly disclose arbitrary numerical values or small ranges included in the ranges, these values and ranges should be deemed to have been specifically disclosed.

### REFERENCE SIGNS LIST

1: computing unit
10: communication unit
11: control unit
12: MTU management unit
2, 2a: communication unit
20: virtual switch
21: communication unit
22: packet processing unit
23: rule DB
3: virtual network
30: communication apparatus
4: control server
40: VM generation unit
41: MTU setting unit
42: MTU management unit
43: MTU management DB
44: switch control unit
45: rule management DB
46: path calculation unit
400: control server
600: OpenFlow switch
700: OpenFlow controller

What is claimed is:

1. A communication system, comprising:
a computing unit that transmits communication data with a plurality of packets; and
a communication unit that performs packet processing for transmitting said packets via a virtual network,
wherein said computing unit adjusts a size of a transmission packet transmitted to said communication unit with a packet size selected from a plurality of packet size candidates based on information regarding a forwarding path of said transmission packet.

2. The communication system according to claim 1, wherein
said computing unit comprises a storage unit that stores a maximum permissible value of a packet size corresponding to information regarding said forwarding path, and
said computing unit is able to adjust the packet size of said transmission packet to said maximum permissible value.

3. The communication system according to claim 1, wherein
said computing unit adjusts the packet size of said transmission packet based on a smallest value among a plurality of maximum transmission units set on said forwarding path.

4. The communication system according to claim 1, wherein
said computing unit adjusts the packet size of said transmission packet to a smallest value among maximum transmission units set on each of a plurality of communication apparatuses constituting said forwarding path.

5. The communication system according to claim 1, wherein
said computing unit adjusts the packet size of said transmission packet to a maximum transmission unit corresponding to a destination of said transmission packet.

6. The communication system according to claim 1, wherein
said computing unit adjusts the packet size of said transmission packet to a maximum transmission unit corresponding to a communication apparatus that performs predetermined processing on said transmit packet on said forwarding path.

7. The communication system according to claim 1, wherein the communication system comprises a control apparatus that collects maximum transmission units set on said forwarding path, and sets a maximum transmission unit calculated by an operation having at least one of collected maximum transmission units as an input and information regarding said forwarding path in said computing unit such that the calculated maximum transmission unit is associated with the information regarding said forwarding path.

8. A communication method in a communication system comprising a computing unit that transmits communication data with a plurality of packets and a communication unit, said communication method comprising:
adjusting a size of a transmission packet with a packet size selected from a plurality of packet size candidates based on information regarding a forwarding path of said transmission packet;
transmitting said transmission packet to said communication unit; and
performing packet processing for transmitting said transmission packet via a virtual network.

9. The communication method according to claim 8, further comprising adjusting the packet size of said transmission packet to a maximum permissible value of a packet size corresponding to information regarding said forwarding path.

10. The communication method according to claim 8, further comprising adjusting the packet size of said transmission packet based on a smallest value among a plurality of maximum transmission units set on said forwarding path.

11. The communication method according to claim 8, further comprising adjusting the packet size of said transmission packet to a smallest value among maximum transmission units set on each of a plurality of communication apparatuses constituting said forwarding path.

12. The communication method according to claim 8, further comprising adjusting the packet size of said transmission packet to a maximum transmission unit corresponding to a destination of said transmission packet.

13. The communication method according to claim 8, further comprising adjusting the packet size of said transmission packet to a maximum transmission unit corresponding to a communication apparatus that performs predetermined processing on said transmit packet on said forwarding path.

14. The communication method according to claim 8, further comprising:
collecting maximum transmission units set on said forwarding path; and
setting a maximum transmission unit calculated by an operation having at least one of collected maximum transmission units as an input and information regarding said forwarding path in said computing unit such that the calculated maximum transmission unit is associated with the information regarding said forwarding path.

15. An information processing apparatus, comprising:
a computing unit that transmits communication data with a plurality of packets; and
a communication unit that performs packet processing for transmitting said packets via a virtual network, wherein
said computing unit adjusts a size of a transmission packet transmitted to said communication unit with a packet size selected from a plurality of packet size candidates based on information regarding a forwarding path of said transmission packet.

16. An information processing apparatus comprising:
a first unit for generating a virtual machine that communicates with a communication unit which performs packet processing for transmitting a packet via a virtual network; and
a second unit for setting information regarding a forwarding path of the packet and a packet size corresponding to said information in a storage unit to which said virtual machine refers in order to adjust a size of a transmission packet transmitted to said communication unit.

17. The information processing apparatus according to claim 16, wherein
said second unit sets a maximum permissible value of a packet size corresponding to information regarding said forwarding path in said storage unit.

18. The information processing apparatus according to claim 16, wherein
said second means sets a packet size in said storage unit based on the smallest value among a plurality of maximum transmission units configured on said forwarding path.

19. The information processing apparatus according to claim 16, wherein
said second unit collects maximum transmission units set on said forwarding path, and sets a maximum transmission unit calculated by an operation having at least one of collected maximum transmission units as an input and information regarding said forwarding path in said storage unit such that the calculated maximum transmission unit is associated with the information regarding said forwarding path.

20. The information processing apparatus according to claim 16, wherein
said second unit sets a packet size in said storage unit based on a smallest value among maximum transmission units set on each of a plurality of communication apparatuses constituting said forwarding path.

21. The information processing apparatus according to claim 16, wherein
said second unit sets a maximum transmission unit corresponding to a destination of said transmission packet in said storage unit.

22. The information processing apparatus according to claim 16, wherein
said second unit sets a maximum transmission unit corresponding to a communication apparatus that performs predetermined processing on said transmit packet on said forwarding path in said storage unit.

23. A communication control method, comprising:
generating a virtual machine that communicates with a communication unit that performs packet processing for transmitting a packet via a virtual network; and
setting information regarding a forwarding path of the packet and a packet size corresponding to said information in a storage unit to which said virtual machine refers in order to adjust a size of a transmission packet transmitted to said communication unit.

24. A non-transitory computer-readable recording medium storing a program having a computer execute:
a process of generating a virtual machine that communicates with a communication unit that performs packet processing for transmitting a packet via a virtual network; and
a process of setting information regarding a forwarding path of the packet and a packet size corresponding to said information in a storage unit to which said virtual machine refers in order to adjust a size of a transmission packet transmitted to said communication unit.
